(19) United States
(12) Patent Application Publication
(10) Pub. No.: US 2024/0288901 A1
(43) Pub. Date: Aug. 29, 2024

(54) THREE-SCREEN SPLIT DISPLAY DEVICE

(71) Applicant: Shenzhen E-Tech Digital Technology Co., Ltd., ShenZhen (CN)

(72) Inventor: Yang GU, ShenZhen (CN)

(21) Appl. No.: 18/507,970

(22) Filed: Nov. 13, 2023

(30) Foreign Application Priority Data
Feb. 24, 2023 (CN) 2023203003010

(51) Int. Cl. G06F 1/16

(52) U.S. Cl. CPC G06F 1/1647; G06F 1/1616; G06F 1/1624; G06F 1/1656; G06F 1/1681

(57) ABSTRACT

The present disclosure relates to a three-screen split display device. The screen split display device includes a middle plate, side display screens and an upper display screen. The middle plate is used to be fixed on the back of a laptop screen. The upper display screen is hinged with the upper part of the middle plate. One side of the side display screen is hinged with one sliding plate. The sliding plate is provided at a side edge of the middle plate. The sliding plate is used to clamp onto a side edge of the laptop screen. The sliding plate is connected to the middle plate, and the sliding plate and the side display screen can be horizontally translated relative to the middle plate. This structure can realize the installation of 1-3 display screens. One same structure can be assembled into products with different number of display screens.

### CROSS-REFERENCE TO RELATED APPLICATION

This application claims priority from the Chinese patent application 2023203003010 filed Feb. 24, 2023, the content of which is incorporated herein in the entirety by reference.

### TECHNICAL FIELD

The present disclosure relates to an extended display for a laptop, and more specifically to a three-screen split display device.

### BACKGROUND

Laptops are one of the common types of computer terminals on the market. Generally, a laptop is composed of a single display screen and a flat computer body. When in use, the contents on the display screen can only be seen from the illuminated side of the display screen and cannot be seen from the back or both sides of the laptop. There are some portable dual-screen laptops used for special occasions, which have two screens that fold into each other. One screen is for the operator to observe, and the other screen faces outward for consumers to observe and confirm information. There are also some screen split display devices that can be installed externally on a laptop screen and expand the screen after being connected to the laptop. The Chinese patent ZL202021965962.8 discloses a screen split display device for a laptop, wherein two display screens are respectively provided on left and right support plates, and the left and right support plates are linked through two sliding arms, one of which is linked to the support plate on the other side through a gear rack structure. When adjusting the clamping width, the left and right support plates synchronously translate with the display screen. Therefore, if a third display screen needs to be added, it is obvious that the third display screen cannot be directly installed on the two movable support plates, so the structure needs to be improved.

### SUMMARY

The purpose of the present disclosure is to provide a three-screen split display device to overcome the above defects of the prior art.

In order to achieve the above purpose, the present disclosure uses the following technical solution: a three-screen split display device, comprising a middle plate, side display screens and an upper display screen, wherein the middle plate is used to be fixed on the back of a laptop screen, the upper display screen is hinged with the upper part of the middle plate; one side of the side display screen is hinged with one sliding plate, the sliding plate is provided at a side edge of the middle plate, the sliding plate is used to clamp onto a side edge of the laptop screen, the sliding plate is connected to the middle plate, and the sliding plate and the side display screen can be horizontally translated relative to the middle plate.

Compared with the prior art, the beneficial effect of the present disclosure is as follows: by setting the middle plate to be fixed behind the laptop screen, hinging the upper display screen to the upper part of the middle plate, and movably connecting the side display screens to the middle plate through the sliding plates, it is possible to choose to install two display screens on both sides of the middle plate or one display screen on one side, or choose to install a total of three display screens on both sides and the upper part of the middle plate. This structure can realize the installation of 1-3 display screens, without the situation that the third display screen cannot be installed adaptively, thus having a better adaptability. One same structure can be assembled into products with different number of display screens, which can meet the needs of different consumers.

Further, at least one tie rod is fixed in the sliding plate, the tie rod is inserted into the middle plate and forms a movable connection with the middle plate, and the degree of freedom of the sliding plate is linear motion along the length direction of the tie rod. The tie rods are divided into an upper tie rod and a lower tie rod which are parallel to each other, the lower tie rod is provided with a rack, a gear is provided in the middle plate, and the rack of the lower tie rod engages with the gear; and the upper tie rod is provided with a wire-passing hole extending along the length direction of the upper tie rod, and a wire harness connected to the side display screen passes through the wire-passing hole.

Further, a hinge shaft between the upper display screen and the upper part of the middle plate is provided with a through hole, and a wire harness connected to the upper display screen passes through the through hole.

Further, when the screen split display device is folded, the sliding plates fit against side edges of the middle plate, the side display screens are rotated and retracted in front of the middle plate, and the upper display screen is rotated and retracted behind the middle plate.

Further, the sliding plates are provided with clamping blocks on the sides facing the middle plate, and the clamping blocks are used to be buckled on left- and right-side edges of the laptop screen. The clamping block comprises an insertion rod and a top cap, the inner end of the insertion rod is inserted into a side of the sliding plate to form a fixation, the inner cavity of the top cap is detachably sleeved on the outer end of the insertion rod, and the side walls of one same top cap have at least two different thicknesses.

Further, magnets are provided in the sliding plates, and when the screen split display device is folded, the magnets are used to fix the retracted side display screens and upper display screen through magnetic attraction.

Further, there are two side display screens, and they are respectively provided on both sides of the middle plate, the sliding plates correspond to the side display screens one-to-one, the relative distance between the sliding plates on both sides is adjustable and the angles of the side display screens relative to the laptop screen are adjustable.

Further, a telescopic support leg that can be unfolded and folded rotatably is provided on the back of the middle plate.

The above description is merely an overview of the technical solution of the present disclosure. In order to understand the technical means of the present disclosure more clearly, it can be implemented in accordance with the content of the specification, and in order to make the above and other purposes, features and advantages of the present disclosure more obvious and easier to understand, preferred embodiments are specifically cited below, which are described in detail as follows.

### BRIEF DESCRIPTION OF THE DRAWINGS

FIG. 1 is a three-dimensional diagram of a screen split display device in its unfolded state according to the present disclosure.

FIG. 2 is an exploded diagram of a middle plate and an upper display screen according to the present disclosure.

FIGS. 3 and 4 are both internal structural diagrams of a middle plate and sliding plates according to the present disclosure.

FIG. 5 is a partially exploded diagram of a screen split display device according to the present disclosure.

FIG. 6 is a three-dimensional assembly diagram of a middle plate and sliding plates according to the present disclosure.

FIG. 7 is a partially exploded diagram of a screen split display device according to the present disclosure.

FIG. 8 is an internal structural diagram of a middle plate, sliding plates, side display screens, and an upper display screen according to the present disclosure.

FIG. 9 is an internal structural diagram of a telescopic support leg of a screen split display device according to the present disclosure.

### DETAILED DESCRIPTION OF THE PREFERRED EMBODIMENTS

In order to make the purpose, technical solution and advantages of the present disclosure clearer, the present disclosure will be further described in detail below with reference to the accompanying drawings and specific embodiments.

The technical solution in the embodiments of the present disclosure will be clearly and completely described below in conjunction with the accompanying drawings of the embodiments of the present disclosure; and obviously, the embodiments described are merely some, rather than all, of the embodiments of the present disclosure. All other embodiments obtained by those skilled in the art based on the embodiments of the present disclosure without any creative effort shall fall within the protection scope of the present disclosure.

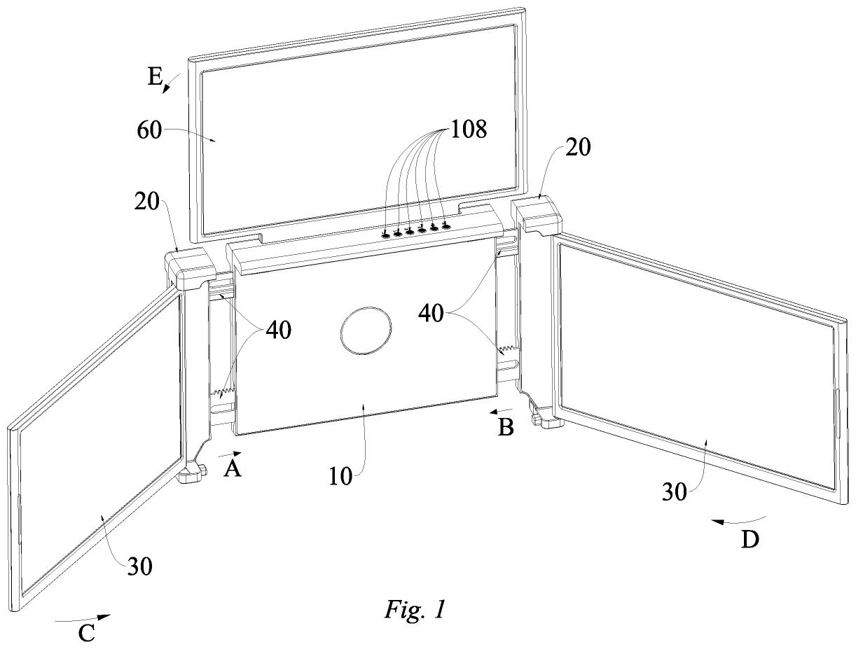

The present disclosure relates to a three-screen split display device, and its specific structure is shown in FIGS. 1 to 9.

As shown in FIG. 1, the screen split display device includes a middle plate 10, side display screens 30 and an upper display screen 60. The middle plate 10 is used to be fixed on the back of a laptop screen. The upper display screen 60 is hinged with the upper part of the middle plate 10. One side of the side display screen 30 is hinged with one sliding plate 20. The sliding plate 20 is provided at a side edge of the middle plate 10. The sliding plate 20 is used to clamp onto a side edge of the laptop screen. The sliding plate 20 is connected to the middle plate 10, and the sliding plate 20 and the side display screen 30 can be horizontally translated relative to the middle plate 10. Specifically, there are two side display screens 30 and they are respectively provided on both sides of the middle plate 10. The sliding plates 20 correspond to the side display screens 30 one-to-one, which means that there are two available side display screens 30 on both sides of the middle plate 10. The relative distance between the sliding plates 20 on both sides is adjustable, which means that it can adapt to laptop screens of different widths. Moreover, the angles of the two side display screens 30 relative to the laptop screen are adjustable, which can realize different viewing angles.

In the present disclosure, by setting the middle plate 10 to be fixed behind the laptop screen, hinging the upper display screen 60 to the upper part of the middle plate, and movably connecting the side display screens 30 to the middle plate 10 through the sliding plates 20, it is possible to choose to install two display screens on both sides of the middle plate 10 or one display screen on one side, or choose to install a total of three display screens on both sides and the upper part of the middle plate 10. This structure can realize the installation of 1-3 display screens, without the situation that the third display screen cannot be installed adaptively, thus having a better adaptability. One same structure can be assembled into products with different number of display screens, which can meet the needs of different consumers.

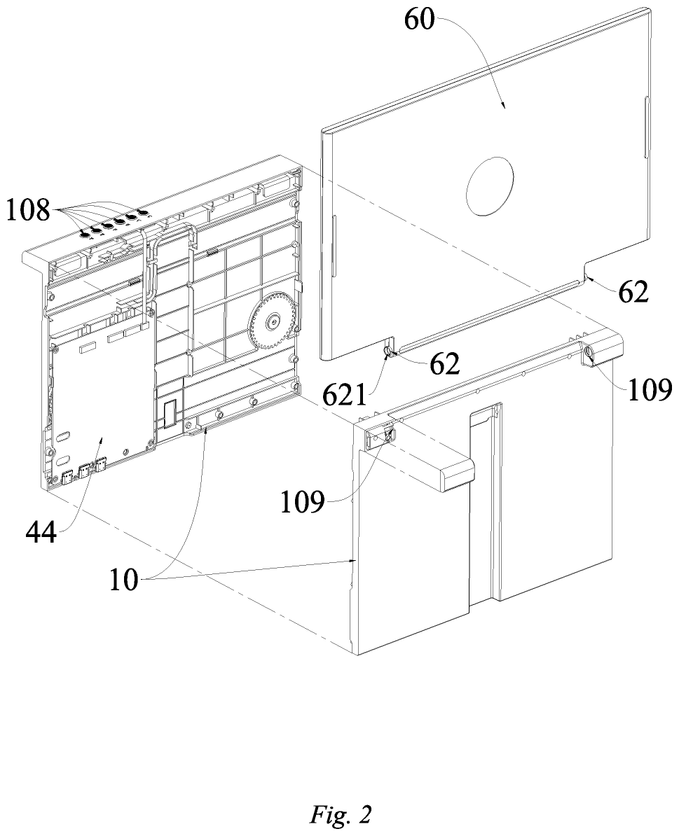

As shown in FIG. 2, the lower part of the upper display screen 60 is inserted into two shaft holes 109 in the upper part of the middle plate 10 through hinge shafts 62 at both ends to form a hinge. One of the hinge shafts 62 is provided with a through hole 621, and the shaft hole 109 corresponding to the through hole 621 communicates with the inside of the middle plate 10. A circuit board 44 is provided in the middle plate 10. A wire harness used for electrical connection between the upper display screen 60 and the circuit board 44 will pass through the through hole 621 and the shaft hole 109 corresponding to the through hole 621. This can prevent the wire harness from being exposed, protect the wire harness and improve the appearance of the product.

In addition, as shown in FIG. 1, buttons 108 for controlling display brightness are provided on the top surface of the middle plate 10. The buttons 108 are electrically connected to the circuit board 44 in the middle plate 10 of FIG. 2. There are six buttons 108, which are used to control the brightness of the side display screens 30 and the upper display screen 30, respectively.

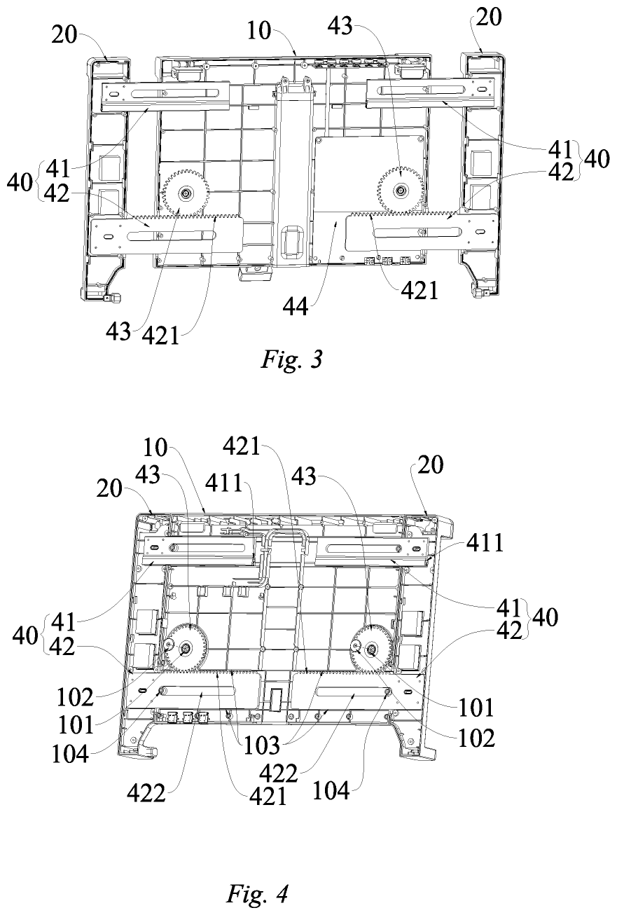

As shown in FIG. 1, the sliding plates 20 on both sides can be separately translated relative to the middle plate 10, that is, the distances between the side display screens 30 on both sides and the middle plate 10 can be adjusted separately to facilitate installation on laptop screens with different widths. Specifically, as shown in FIG. 1, two tie rods 40 are fixed to the sliding plate 20. The tie rods 40 are inserted into the middle plate 10 and form a movable connection with the middle plate 10. The degree of freedom of the sliding plate 20 is linear motion along the length direction of the tie rods 40. In other examples, it is also possible to use only one tie rod 40. As shown in FIGS. 3 and 4, the tie rods 40 are divided into upper tie rods 41 and lower tie rods 42 which are parallel to each other. One end of the lower tie rod 42 at the sliding plate 20 is fixedly connected to the sliding plate 20 through screws, and the other end of the lower tie rod 42 is inserted into the middle plate 10. The upper edge of the lower tie rod 42 is provided with a rack 421, and a gear 43 is provided in the middle plate 10. The rack 421 of the lower tie rod 42 engages with the gear 43. The inner wall of the middle plate 10 is provided with an axle 101, and the gear 43 is sleeved on the axle 101. A pressing ring 102 is pressed onto the axle 101, and the gear 43 is fixed on the axle 101 through the pressing ring 102. In addition, limiting bars 103 are provided on the inner wall of the middle plate 10. The limiting bars 103 extend along the length direction of the lower tie rods 42. The lower tie rods 42 are sandwiched between the two limiting bars 103. The two limiting bars 103 restrict the straight translation direction of the tie rods 42. There are also limiting posts 104 provided on the inner wall of the middle plate 10 between the two limiting bars 103. The lower tie rods 42 are provided with strip grooves 422, and the limiting posts 104 are inserted into the strip grooves 422. When the lower tie rods 42 translate outward to the maximum strokes, the limiting posts 104 abut against the inner ends of the strip grooves 422, thereby limiting the maximum strokes of the lower tie rods 42. As shown in FIG. 4, the upper tie rods 41 also adopt the same structure to achieve stroke limiting.

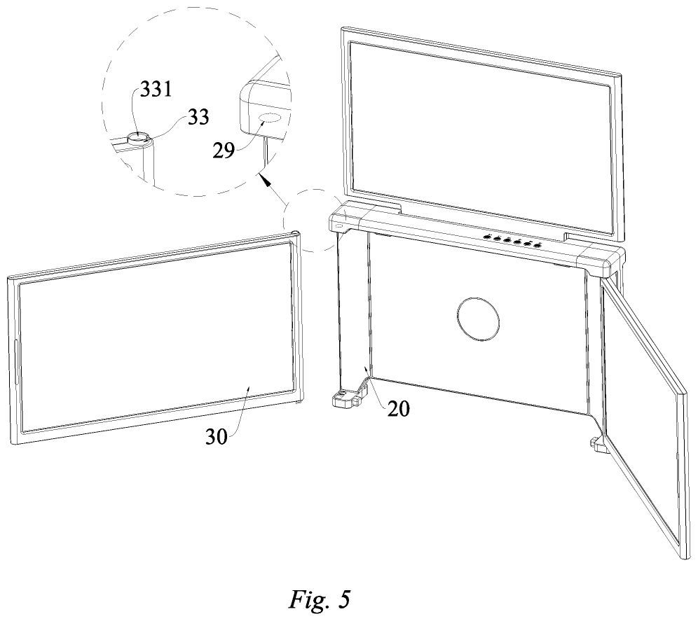

The circuit board 44 in the middle plate 10 is electrically connected to the side display screens 30. As shown in FIG. 4, the two upper tie rods 41 are both provided with wire-passing holes 411 which extend along the length direction of the upper tie rods 41. During wiring, wire harnesses used for connecting the circuit board 44 and the side display screens 30 pass through the wire-passing holes 411 and then enter the sliding plates 20, and then pass through shaft holes 29 of the sliding plates 20 and shaft holes 331 of hinge shafts 33 of the side display screens 30 as shown in FIG. 5, and finally enter the side display screens 30. With such a structure, the wire harnesses can be hidden in the upper tie rods 41 and the sliding plates 20 to prevent the wire harnesses from being exposed.

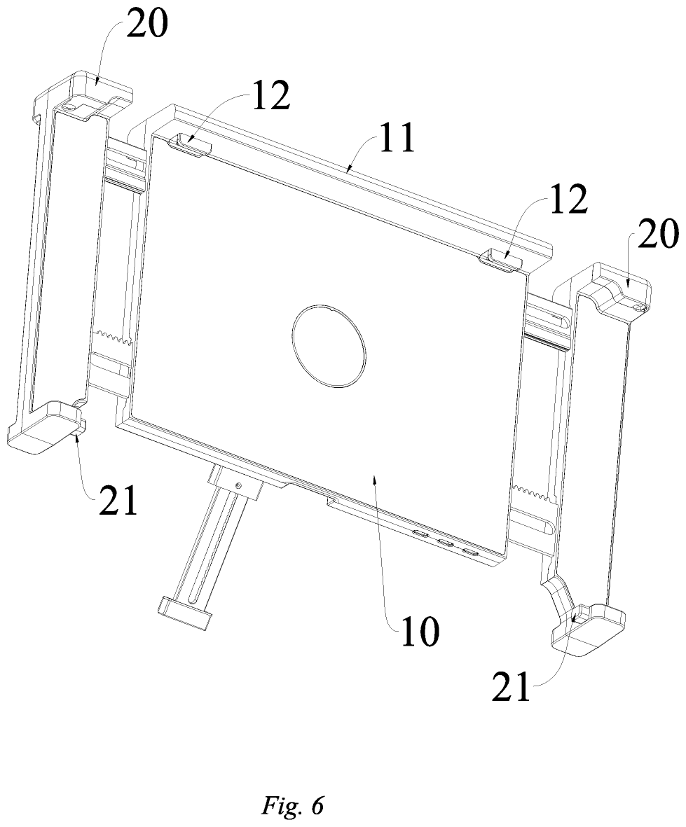

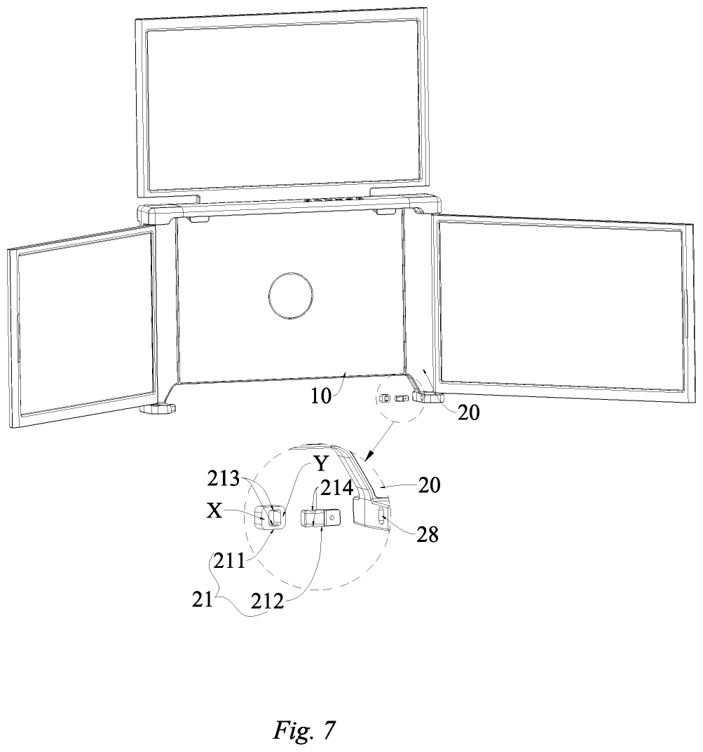

As shown in FIG. 6, a protruding plate 11 above the middle plate 10 is provided with two U-shaped buckles 12 with openings facing downwards, and the two sliding plates 20 are provided with clamping blocks 21 on the sides facing the middle plate 10. When in use, the two U-shaped buckles 12 need to be buckled on the upper edge of a laptop screen. After adjusting the clamping width, the two clamping blocks 21 are buckled on the left- and right-sides of the laptop screen so that the laptop screen is clamped between the clamping blocks 21 and the middle plate 10. During implementation, the surfaces of the U-shaped buckles 12 that are in contact with the laptop screen should be made of flexible cushioning material (such as pearl cotton or foam board) to avoid damage to the laptop screen. Specifically, as shown in FIG. 7, the clamping block 21 includes an insertion rod 212 and a top cap 211. The top cap 211 is used to contact the laptop screen, so the top cap 211 should also be made of flexible cushioning material (such as pearl cotton or foam board). The inner end of the insertion rod 212 is inserted into a side through hole 28 of the sliding plate 20 and fixed through screw connection. The top cap 211 is detachably sleeved on the outer end of the insertion rod 212 and forms a snap connection. The sidewalls of one same top cap 211 have at least two different thicknesses. In an exemplary structure of FIG. 7, the outer end of the insertion rod 212 is provided with two grooves 214 on top and bottom respectively, and the inner wall of the top cap 211 is provided with two convex strips 213 on top and bottom correspondingly. When the top cap 211 is sleeved on the outer end of the insertion rod 212, the convex strips 213 snap into the grooves 214 to form a snap connection. The thicknesses of a side wall X and a side wall Y between the two convex strips 213 of the top cap 211 are different. The thickness of the side wall X is relatively large, which is suitable for scenarios where the thicknesses of laptop screens are relatively small; and the thickness of the side wall Y is relatively small, which is suitable for scenarios where the thicknesses of laptop screens are relatively large. When in use, according to the thickness of a laptop screen, the side wall X or the side wall Y of the top cap 211 is selected to face the middle plate 10, so as to sleeve the top cap 211 on the outer end of the insertion rod 212, which can avoid an unsatisfactory clamping effect on screens with different thicknesses. In the exemplary structure of FIG. 7, the cross-section of the top cap 211 is a quadrilateral. In other examples, the cross-section of the top cap can also be made into a polygon. The shape of the outer end of the insertion rod also needs to be adapted to the cross-sectional shape of the top cap. The side walls can be provided with more than 2 different thicknesses, so it can realize more clamping scenarios for laptop screens with different thicknesses. In yet another example, the outer end of the insertion rod can rotate relative to the inner end of the insertion rod, and the rotation axis of the outer end of the insertion rod is the axis of the insertion rod itself. With this structure, for screens with different thicknesses, it is possible to directly rotate the top cap to choose side walls of different thicknesses to face the middle plate, without the need for cumbersome adjustment steps of removing the top cap and adjusting it before inserting the insertion rod.

When the screen split display device is not in use, the screen split display device can be folded to reduce space occupation. When folding the screen split display device, as shown in FIG. 1, the sliding plates 20 on both sides can be translated toward the middle plate 10 along the directions A and B respectively until the sliding plates 20 fit against side edges of the middle plate 10. Then, the left-side display screen 30 is rotated along the direction C and retracted in front of the middle plate 10, and then the right-side display screen 30 is rotated and retracted in front of the left-side display screen 30. As shown in FIG. 1, in the translation direction of the sliding plates 20, a hinge position between the left-side display screen 30 and the sliding plate 20, and a hinge position between the right-side display screen 30 and the sliding plate 20 are staggered from each other, which can avoid interference and obstruction between the left- and right-side display screens 30 during folding. When folding the screen split display device, the upper display screen 60 also needs to be rotated along the direction E and retracted behind the middle plate 10.

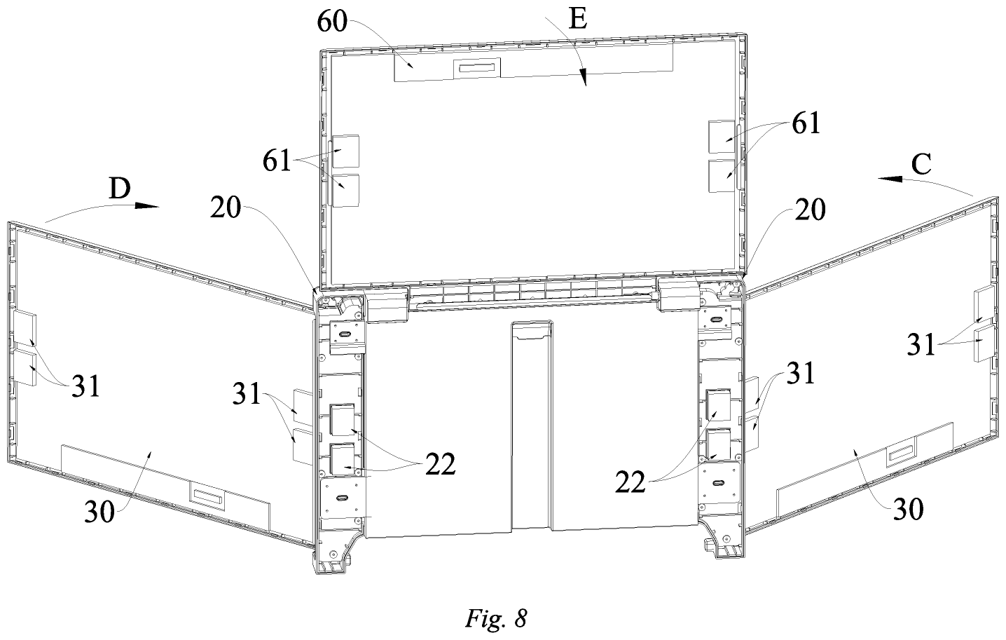

In addition, as shown in FIG. 8, two magnets 22 are provided at a middle position inside each sliding plate 20. When the screen split display device is folded, the magnets 22 are used to fix the retracted side display screens 30 and the upper side display screen 60 through magnetic attraction. Specifically, as shown in FIG. 8, two magnets 31 are correspondingly provided on each of both sides inside each of the side display screens 30. After the side display screens 30 on both sides are rotated along the direction C and the direction D respectively and retracted, the magnets 31 in the side display screens 30 form magnetic attraction with the magnets 22 in the sliding plates 20 correspondingly, so that the side display screens 30 are fixed through the magnetic attraction, so as to prevent the retracted side display screens 30 from automatically rotating and unfolding outward. After the upper display screen 60 is rotated along the direction E and retracted, magnets 61 in the upper display screen 60 form magnetic attraction with the magnets 22 in the sliding plates 20 correspondingly, so that the upper display screen 60 is fixed through the magnetic attraction, so as to prevent the retracted upper display screen 60 from automatically rotating and unfolding outward. The magnets 22, magnets 31 and magnets 61 can all use N52 strong magnets.

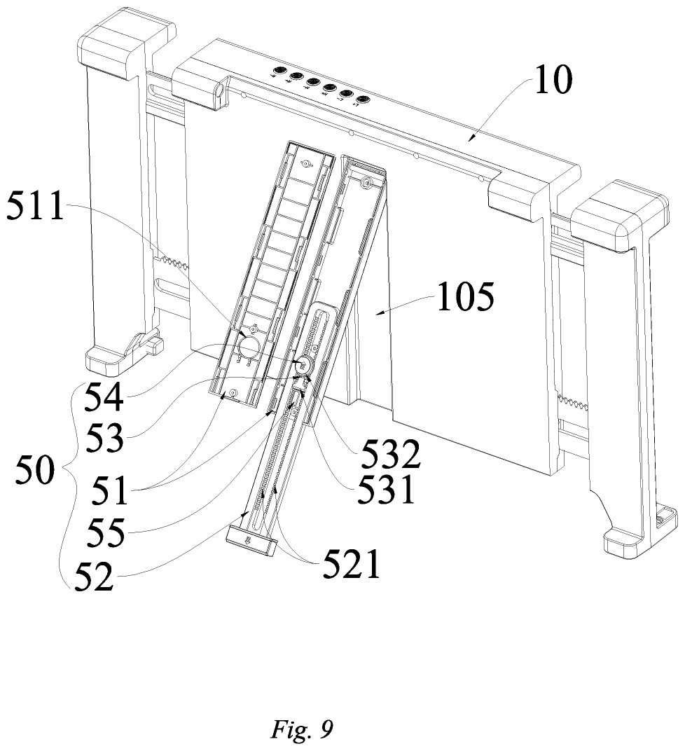

As shown in FIG. 9, a telescopic support leg 50 that can be unfolded and folded rotatably is provided on the back of the middle plate 10. Specifically, the telescopic support leg 50 includes an elongated casing 51, a support rod 52, and a locking member 53. The support rod 52 can slide linearly relative to the casing 51. The support rod 52 is provided with two parallel racks 521 extending along the length direction. The locking member 53 includes a pressing end 532 and an engaging end 531 that are connected. The locking member 53 rotates around the joint of the pressing end 532 and the engaging end 531. A compression spring 54 is used to push the pressing end 532 so that the engaging end 531 and the racks 521 remain engaged and locked. One end of the compression spring 54 abuts the inner wall of the casing 51, and the other end penetrates into and abuts the pressing end 532. The casing 51 is provided with a through hole 511 at a position corresponding to the pressing end 532 for the pressing end 532 to pass through and be exposed. In addition, a magnet 55 is provided in the casing 51, and an iron block (not shown) or a magnet (not shown) is placed at a position corresponding to the magnet 55 in a strip groove 105 behind the middle plate 10, and the telescopic support leg 50 is fixed in the strip groove 105 behind the middle plate 10 by generating magnetic attraction.

In the description of the present disclosure, it should be understood that the orientation or positional relationship indicated by terms “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise” and the like is based on the orientation or positional relationship shown in the drawings, which is merely for the convenience of describing the present disclosure and for the simplification of the description, and not to indicate or imply that the means or element referred to must have a specific orientation, be constructed and operated in a specific orientation. Therefore, the above terms shall not be construed as a limitation of the present disclosure.

In addition, terms “first” and “second” are used merely for descriptive purposes, and should not be construed as indicating or implying relative importance or implicitly indicating the number of technical features indicated. Thus, features defined with “first” and “second” can explicitly or implicitly comprise one or more of the features. In the description of the present disclosure, the meaning of “a plurality of” is two or more, unless specifically defined otherwise.

In the present disclosure, unless otherwise explicitly specified and limited, a first feature being “above” or “below” a second feature may include situations where the first feature and the second feature are in direct contact, and the first feature and the second feature are not in direct contact but are in contact through another feature between them. Moreover, a first feature being “on”, “above”, and “over” a second feature includes situations where the first feature is directly above or obliquely above the second feature, or simply indicates that the horizontal level of the first feature is higher than that of the second feature. A first feature being “under”, “below”, and “beneath” a second feature includes situations where the first feature is directly below or obliquely below the second feature, or simply indicates that the horizontal level of the first feature is lower than that of the second feature.

In the description of this specification, descriptions with reference to terms “one embodiment”, “some embodiments”, “an example”, “a specific example”, or “some examples” etc., mean specific features, structures, materials or characteristics described in conjunction with the embodiment(s) or example(s) are included in at least one embodiment or example of the present disclosure. In this specification, the schematic representation of the above-mentioned terms should not be constructed as necessarily referring to the same embodiment or example. Moreover, the described specific features, structures, materials or characteristics may be combined in any one or more embodiments or examples in a suitable manner. In addition, those skilled in the art may combine different embodiments or examples described in this specification.

The above only uses embodiments to further illustrate the technical content of the present disclosure, so as to make it easier for readers to understand, but it does not mean that the implementation of the present disclosure is limited to this. Any technical extension or re-creation made in accordance with the present disclosure is all protected by the present disclosure. The protection scope of the present disclosure is defined by the claims.

1. A three-screen split display device, comprising a middle plate, side display screens and an upper display screen, wherein the middle plate is used to be fixed on the back of a laptop screen, the upper display screen is hinged with the upper part of the middle plate; one side of the side display screen is hinged with one sliding plate, the sliding plate is provided at a side edge of the middle plate, the sliding plate is used to clamp onto a side edge of the laptop screen, the sliding plate is connected to the middle plate, and the sliding plate and the side display screen can be horizontally translated relative to the middle plate.

2. The three-screen split display device of claim 1, wherein at least one tie rod is fixed in the sliding plate, the tie rod is inserted into the middle plate and forms a movable connection with the middle plate, and the degree of freedom of the sliding plate is linear motion along the length direction of the tie rod.

3. The three-screen split display device of claim 2, wherein the tie rods are divided into an upper tie rod and a lower tie rod which are parallel to each other, the lower tie rod is provided with a rack, a gear is provided in the middle plate, and the rack of the lower tie rod engages with the gear; and the upper tie rod is provided with a wire-passing hole extending along the length direction of the upper tie rod, and a wire harness connected to the side display screen passes through the wire-passing hole.

4. The three-screen split display device of claim 1, wherein a hinge shaft between the upper display screen and the upper part of the middle plate is provided with a through hole, and a wire harness connected to the upper display screen passes through the through hole.

5. The three-screen split display device of claim 1, wherein when the screen split display device is folded, the sliding plates fit against side edges of the middle plate, the side display screens are rotated and retracted in front of the middle plate, and the upper display screen is rotated and retracted behind the middle plate.

6. The three-screen split display device of claim 1, wherein the sliding plates are provided with clamping blocks on the sides facing the middle plate, and the clamping blocks are used to be buckled on left- and right-side edges of the laptop screen.

7. The three-screen split display device of claim 6, wherein the clamping block comprises an insertion rod and a top cap, the inner end of the insertion rod is inserted into a side of the sliding plate to form a fixation, the top cap is detachably sleeved on the outer end of the insertion rod, and the side walls of one same top cap have at least two different thicknesses.

8. The three-screen split display device of claim 1, wherein magnets are provided in the sliding plates, and when the screen split display device is folded, the magnets are used to fix the retracted side display screens and upper display screen through magnetic attraction.

9. The three-screen split display device of claim 1, wherein there are two side display screens and they are respectively provided on both sides of the middle plate, the sliding plates correspond to the side display screens one-to-one, the relative distance between the sliding plates on both sides is adjustable and the angles of the side display screens relative to the laptop screen are adjustable.

10. The three-screen split display device of claim 1, wherein a telescopic support leg that can be unfolded and folded rotatably is provided on the back of the middle plate.

11. The three-screen split display device of claim 2, wherein there are two side display screens and they are respectively provided on both sides of the middle plate, the sliding plates correspond to the side display screens one-to-one, the relative distance between the sliding plates on both sides is adjustable and the angles of the side display screens relative to the laptop screen are adjustable.

12. The three-screen split display device of claim 3, wherein there are two side display screens and they are respectively provided on both sides of the middle plate, the sliding plates correspond to the side display screens one-to-one, the relative distance between the sliding plates on both sides is adjustable and the angles of the side display screens relative to the laptop screen are adjustable.

13. The three-screen split display device of claim 4, wherein there are two side display screens and they are respectively provided on both sides of the middle plate, the sliding plates correspond to the side display screens one-to-one, the relative distance between the sliding plates on both sides is adjustable and the angles of the side display screens relative to the laptop screen are adjustable.

14. The three-screen split display device of claim 5, wherein there are two side display screens and they are respectively provided on both sides of the middle plate, the sliding plates correspond to the side display screens one-to-one, the relative distance between the sliding plates on both sides is adjustable and the angles of the side display screens relative to the laptop screen are adjustable.

15. The three-screen split display device of claim 6, wherein there are two side display screens and they are respectively provided on both sides of the middle plate, the sliding plates correspond to the side display screens one-to-one, the relative distance between the sliding plates on both sides is adjustable and the angles of the side display screens relative to the laptop screen are adjustable.

16. The three-screen split display device of claim 7, wherein there are two side display screens and they are respectively provided on both sides of the middle plate, the sliding plates correspond to the side display screens one-to-one, the relative distance between the sliding plates on both sides is adjustable and the angles of the side display screens relative to the laptop screen are adjustable.

17. The three-screen split display device of claim 8, wherein there are two side display screens and they are respectively provided on both sides of the middle plate, the sliding plates correspond to the side display screens one-to-one, the relative distance between the sliding plates on both sides is adjustable and the angles of the side display screens relative to the laptop screen are adjustable.
